(19) United States
(12) Patent Application Publication
(10) Pub. No.: US 2024/0334908 A1
(43) Pub. Date: Oct. 10, 2024

(54) Cat Chew Toy

(71) Applicant: Samantha Anne McConnell, Richmond (Ca)

(72) Inventor: Samantha Anne McConnell, Richmond (Ca)

(21) Appl. No.: 18/132,381

(22) Filed: Apr. 8, 2023

(51) Int. Cl. A01K 15/02

(52) U.S. Cl. CPC A01K 15/026

(57) ABSTRACT

The present invention relates to a novel cat chew toy that is developed from natural materials and promotes dental health in addition of providing amusement and enjoyment to the cats. The proposed assembly is economical, is developed from natural ingredients thus is safe and effective, and is an interactive toy that keeps the cats engaged and relaxed.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates generally to toys for pets, and, more particularly, to chew toys for cats.

### Description of the Related Art

For centuries pet owners have looked for simple toys which can help give pets exercise and entertainment. Dog owners have played fetch with their pets using balls or sticks, and these devices are often acceptable to draw and maintain the attention of a dog. However, not all pets are as easily entertained as dogs. For instance, cat owners face a greater challenge than dog owners when it comes to entertaining their pets. Therefore, pet toys to amuse cats require a greater degree of creativity.

There is a reasonable amount of related art in the field of cat toys. Some examples relate to strings attached to a wand, fake mice, birds, balls within a track and other items. For instance, U.S. Pat. No. 8,944,011 by Kirschbaum discloses an impact action cat toy where the cat owner creates erratic movements of a cat toy play member which is situated at the end of a cord. The cat toy play member can be constructed using a cork and feathers, and the cat owner creates the movement of the toy by moving the rigid tube in a wand like fashion. Similarly, Patent Application No. U.S. 2005/010468 A1 by Fleischhacker discloses a hallow mouse tethered to a fishing reel and rod type assembly. To operate this invention, the cat owner again directs the movements of the hallow mouse by moving and operating the fishing reel and rod to which it is attached.

U.S. Pat. No. 6,032,615 by Girard discloses a ball contained in a track system which appears to simulate a mouse going into a hole. A cat playing with this device can touch the ball, but the ball will always move away from the cat within the confined track. Similarly, U.S. Pat. No. 5,579,725 by Boshears includes a toy animal simulating a mouse contained within a circular housing. Boshears also provides a motorized device where the toy animal is mounted on the outer end of a motor-driven arm. A cat playing with this toy will catch the toy animal momentarily, but the toy animal will begin moving again in a circular pattern through the motor driven arm once released.

More specifically, U.S. Pat. No. 3,830,202 discloses a two-ended pet toy that includes a flexible rope that is partially jacketed by a solid, bowling-pin shaped, outer structure. Often a pet may bite down on one end of the rope in its mouth and shake its head holding the end of the rope in its mouth. As a result, the solid, outer structure may fly around and slap the pet in the head causing pain and discomfort and perhaps injury to the pet. In this respect, it would be desirable if a pet toy were provided which did not include a solid object that jackets part of a flexible rope and that can slide along the flexible rope.

U.S. Pat. No. 4,133,296 discloses a two-ended pet toy that has weights located at opposite ends of a flexible tubular member. U.S. Pat. No. 5,033,410 discloses a two-ended pet toy that is rope-like and has bristle structure. The toy may be impregnated with flavor material. U.S. Pat. No. 5,174,243 a two-ended pet toy that has bone-like covers at either end and a rope-like structure connecting the two ends. In all of the above-mentioned two-ended toys for pets, the amount and type of play activity that can be employed by either the person with the pet or the pet by itself is relatively limited. In this respect, it would be desirable if a pet toy were provided which were not limited by the play activities provided by a two-ended pet toy.

U.S. Pat. No. 5,092,272 discloses a pet toy based on rope that has two free ends and a closed loop for a third end. The closed loop has its own handle which jackets a rope portion. A disadvantage of the jacket for the rope portion is that the jacket may fall apart during rough play and cause a hazard to the eyes and the throat of the pet. In this respect, it would be desirable if a rope-base pet toy were provided which did not include a jacket for a portion of the rope. Another disadvantage of the toy in this patent is the presence of a dosed loop. A pet may get its head caught in the closed loop and may possibly choke therefrom. In this respect, it would be desirable if a pet toy were provided which did not include a closed loop. Still another disadvantage is present in the toy in this patent. The two free ends project in one direction from the joined region between the two free ends, and the looped end projects in an opposite direction. Because of the differences in directional orientation of the parts of the toy, the pet may favor one end over another and cause premature wear at a favored end. In this respect, it would be desirable if a pet toy were provided which had three equivalent free ends so that one free end would not be favored by a pet causing premature wear of the favored end.

As mentioned above, U.S. Pat. No. 5,033,410 discloses a rope-like toy that is impregnated with flavor material. The presence of flavor material may provide benefits in inducing the pet to chew, which may be a healthy activity. However, a limited amount of flavor material may be carried by the rope-like material. Once the limited amount of flavor material is used up, the toy no longer bears the flavor. In this respect, it would be desirable if a pet toy were provided which permitted periodic addition of flavor material without depending upon only an initial amount of impregnated flavoring material.

Durability requires that the pet toy resist damage or destruction for a prolonged period. Price attractiveness to a purchaser (“price attractiveness”) requires that the selling price of the pet toy be properly positioned for the kind of pet toy that is being purchased. Since the retail price is typically multiples of the manufacturing costs, price attractiveness means that the cost of manufacture be appropriate for the toy. However, as each of the general criteria is met, the costs increase.

Although the prior art may be adequate for its intended purposes, a need still exists for a durable toy designed specifically for cats that may be developed from high-quality material to enhance its life and usage but also promotes clean and healthy teeth. Furthermore, a need still exists for a chewable cat toy that is durable and which maintained is developed from natural and eco-friendly materials, and can be easily manufactured.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of the cat toy.

Another object of the present invention is to provide a chewable cat toy, developed in form of natural Silvervine Sticks, thus enhancing the life and usefulness of the toy over a longer period.

Another object of this invention is to provide a new and improved toy that is inexpensive but durable in nature and keeps the cats entertained for hours with our long-lasting Silvervine Sticks. The proposed assembly is universal in nature and is suitable for cats of all ages and sizes.

It is an object of the invention in one of its aspects to provide an advanced form of toy which is made from sisal rope that helps provide texture so when the cats bite, it reduces plaque build-up.

Yet another object of the present invention is to provide a structure that is relatively inexpensive to produce so that ownership is available to a substantial majority of dog owners.

It is a further aspect of the present invention to provide a new and improved assembly that is of durable and reliable and can sustain its effectiveness after multiple and consistent uses.

Thus, it is the objective to provide a new and improved cat chew sticks that act as a fun and interactive toy, a training tool, assist the cat to be relaxed. Other aspects, advantages, and novel features of the present invention will become apparent from the detailed description of the invention when considered in conjunction with the accompanying drawings.

This Summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the complete assembly of the cat chew toy showing my new design;

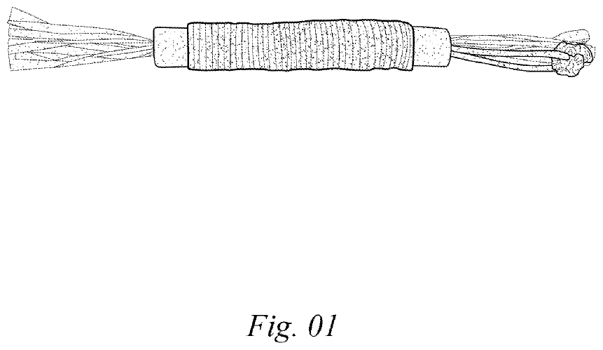

FIG. 2 shows the vertical top view of the cat chew toy as per preferred embodiments of the invention.

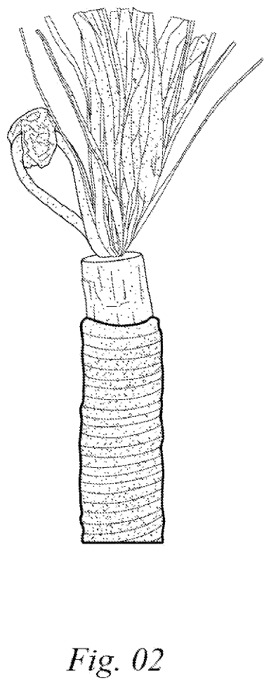

FIG. 3 shows the vertical bottom view of the cat chew toy as per preferred embodiments of the invention.

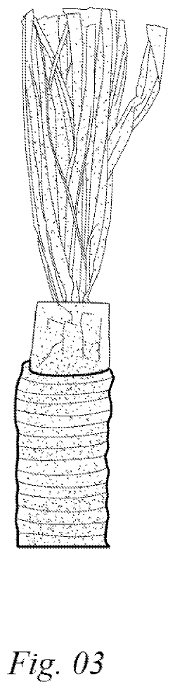

FIG. 4 shows the multiple assemblies of cat chew toy as per preferred embodiments of the invention.

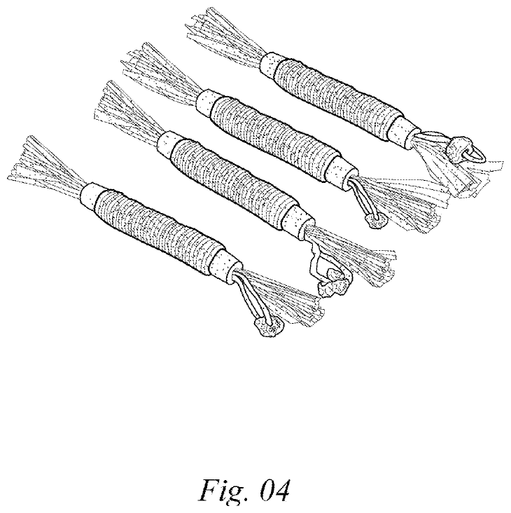

FIG. 5 shows the perspective use of the cat chew toy as per preferred embodiments of the invention.

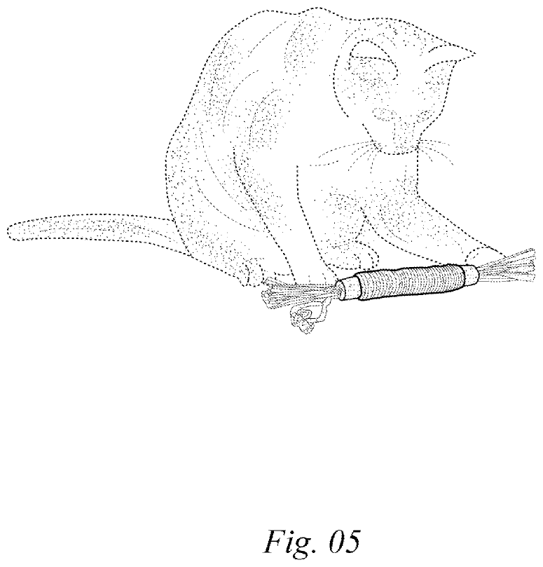

Skilled artisans will appreciate those elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Pets, are known for their penchant to bite, gnaw and otherwise chew upon objects, particularly items that may spur their natural instincts. Unfortunately, cats may also chew objects such furniture, shoes, hats and other household items causing unwanted damage thereto.

In light of the above, numerous toys have been developed to provide cats with an enjoyable object to chew. Preferably, such toys are a distraction to which the cats, or any other pet, will direct its attention and chew upon instead of coveted items such as household décor.

While most cats may enjoy chewing on objects, preferences appear to vary as to the hardness of the substances favored. Some cats may like to chew on hard materials while other cats may prefer softer materials such as rubber or other elastomers.

The present invention as per its preferred embodiments discloses a Silvervine Sticks for Cats. The product is intended to be long-lasting and durable. In accordance with one or more embodiments of the present invention, each toy comprises a material that resists destruction, i.e., “a destruction-resistant material.” Specifically, in accordance with one or more embodiments of the present invention, each toy comprises a destruction-resistant material alone or in combination with another material and is made according to an industrially economical method. The destruction-resistant material may be Silvervine Sticks that are made with premium, 1000% natural ingredients, which is taught further herein, alone or combined with another material. However, in accordance with one or more embodiments of the present invention, the destruction-resistant material consists solely of Silvervine Sticks, which is taught further herein.

As per further embodiments of the invention, the assembly is composed of the first flexible rope arm that includes a first-end knot. The second flexible rope arm includes a second-end knot. The third flexible rope arm includes a third-end knot. The first flexible rope arm includes a braided first middle portion. The second flexible rope arm includes a braided second middle portion. The third flexible rope arm includes a braided third middle portion. Each portion is tied up to form an assembly that is strong, resistant and playful for the cat.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A new and improved chew toy for cats, comprising:
a Silvervine Sticks knot node, and
a first flexible Silvervine side, a second flexible Silvervine side, and a third flexible Silvervine side depending from said main knot node,
wherein each of said first, second and third flexible Silvervine sides includes an end knot, a braided middle portion extending between said node and said end knot, and an unbraided open-stranded free end extending from said end knot.

2. The chew toy described in claim 1, is developed from natural material.

3. The chew toy described in claim 1, is suitable for all types of cats.

4. The chew toy described in claim 1, reduces plaque buildup and promotes white and shining teeth.
